(19) United States
(12) Patent Application Publication
(10) Pub. No.: US 2026/0214371 A1
(43) Pub. Date: Jul. 23, 2026

(54) HEADPHONE DEVICE WITH AUTOMATIC CONSTRUCTION CHARACTERISTIC DETECTION

(71) Applicant: EPOS Group A/S, Ballerup (DK)

(72) Inventor: Svend FELDT, Smørum (DK)

(21) Appl. No.: 19/457,210

(22) Filed: Jan. 23, 2026

(30) Foreign Application Priority Data
Jan. 23, 2025 (EP) 25153449.1

(51) Int. Cl. H04R 1/10; H04R 3/04; H04R 29/00

(52) U.S. Cl. CPC H04R 1/1041; H04R 1/1083; H04R 3/04; H04R 29/001; H04R 2460/01

(57) ABSTRACT

Disclosed herein are embodiments of methods performed by a headphone device and headphone devices. The method can involve determining at least one construction characteristic of a headphone device and adjusting sound characteristics based on the at least one construction characteristic. Examples of construction characteristics include ear adaptation type and sound isolation type.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57.

### FIELD

The present disclosure relates to the field of headphone devices. More specifically, the disclosure relates to a method performed by a headphone device, a headphone device, and a computer program.

### BACKGROUND

Headphone devices, such as headphones, headsets or hearing aids, have become everyday objects and their usage is widespread today. Fields of use comprise private life (e.g. for listening to music or podcasts or for making phone calls), professional environments (e.g. for making business video calls or for monitoring purposes in sound and stage engineering), and medical purposes (e.g. for making sound audible to persons with hearing loss).

Headphone devices can be classified into different ear adaption types. For example, a first ear adaption type of headphone devices are over-ear headphone devices, also referred to as circumaural headphone devices or full-size headphone devices, having earcups which encompass the ear. A second ear adaption type of headphone devices are on-ear headphone devices, also referred to as supra-aural headphone devices, having earcups which press against the ears, rather than around them. A third ear adaption type of headphone devices are ear-fitting headphone devices, also referred to as earphones, fitted directly in the outer ear, facing but not inserted in the ear canal. A fourth ear adaption type of headphone devices are in-ear headphone devices, also referred to as canalphones, which are inserted in the ear canal itself.

Furthermore, headphone devices can also be classified into different sound isolation types. For example, a first sound isolation type of headphone devices are closed headphone devices which are constructed such that they block a relatively high amount of ambient sounds. A second sound isolation type of headphone devices are open headphone devices which are constructed such that they block a lower amount of ambient sounds compared to closed headphone devices, thus including more sounds from the environment but also leaking more sound out of the headphone device. A third sound isolation type of headphone devices are semi-open headphone devices which are constructed such that they can be considered as a compromise between closed headphone devices and open headphone devices. In the case of over-ear headphone devices and/or on-ear headphone devices, the sound isolation type may be mainly determined by an earcup type of the headphone device, such as a closed type of an earcup, an open type of an earcup, or a semi-open type of an earcup. In the case of ear-fitting headphone devices and/or in-ear headphone devices, the sound isolation type may be mainly determined by an ear tip type of the headphone device, such as a closed type of an ear tip, an open type of an ear tip, or a semi-open type of an ear tip.

Manufacturers of headphone devices may design different products or product variants such that these differ virtually only in their ear adaption type and/or in their sound isolation type and are essentially identical otherwise, in particular with respect to electronic hardware as well as software. For example, a manufacturer may design a first product as an over-ear headphone device and a second product as an on-ear headphone device, and the first and second products may be essentially identical apart from the respective earcup in order to reduce production costs. In particular, the first and second products may use essentially the same electronic hardware and essentially the same software. As another example, a manufacturer may design a first product as a closed over-ear headphone device and a second product as an open over-ear headphone device, and the first and second products may again be essentially identical apart from the respective earcup. Again, the first and second products may in particular use essentially the same electronic hardware and essentially the same software. Furthermore, it is also conceivable that different product configurations of an otherwise essentially identical headphone device are chosen by a user. For example, a user may select an ear tip size of an in-ear headphone device based on comfort, with the different selectable ear tip sizes also leading to different sound isolation, for example due to a more open fit or a more closed fit. The electronic hardware and the software of the in-ear headphone device remains unchanged in this case, though.

In particular in the above cases, it may be desirable to adjust the sound characteristics of the headphone device to the respective product, product variant or product configuration. More specifically, it may be desirable to use different equalizer (EQ) settings based on the ear adaption type and/or sound isolation type of the particular headphone device to generate a more enjoyable hearing experience. In this context, it is generally conceivable that a user of the headphone device performs a respective configuration of the headphone device, for example in that the user selects a particular ear adaption type and/or sound isolation type according to the product, product variant or product configuration. However, this may be dissatisfying for the user and may deteriorate user experience.

Against this background, there is a need to provide a headphone device with automatic configuration which does not require an ear adaption type and/or sound isolation type to be specified by a user.

### SUMMARY

According to a first aspect, a method is disclosed. The method may be performed by a headphone device. The method may comprise:
determining at least one construction characteristic of the headphone device; and
adjusting at least one sound characteristic of the headphone device based on the at least one construction characteristic determined.

As used herein, a headphone device may be understood as any device which is worn on or around the head of a user and which comprises at least one loudspeaker driver for converting an electrical audio signal to sound waves. Examples of headphone devices according to this definition are in particular headphones, headsets and hearing aids.

As used herein, a construction characteristic of the headphone device may be understood as any property which results from the construction, design and/or configuration of the headphone device and which is related to the acoustic characteristics and/or to the wearing style of the headphone device. An example of a construction characteristic according to this definition is an ear adaption type, i.e. whether the headphone device is an over-ear, on-ear, ear-fitting or in-ear headphone device as specified above. Another example of a construction characteristic according to this definition is a sound isolation type, i.e. whether the headphone device is a closed, open or semi-open headphone device as specified above.

As used herein, determining at least one construction characteristic may be understood as any action which allows the at least one construction characteristic to be specified. For example, determining at least one construction characteristic may comprise performing one or more measurements, obtaining and/or evaluating one or more electric signals, obtaining and/or processing one or more pieces of information, or any combination of these actions.

As used herein, a sound characteristic may be understood as any property related to the sound or sound waves generated by the at least one loudspeaker driver of the headphone device. An example of a sound characteristic according to this definition is a volume of the headphone device, i.e. the absolute volume of sound or sound waves generated by the at least one loudspeaker driver, expressed for example in units of dB or dB(A). Another example of a sound characteristic according to this definition is a frequency characteristic of the headphone device, i.e. the relative volume of different frequencies of sound or sound waves generated by the at least one loudspeaker driver. Another example of a sound characteristic according to this definition is a state or property related to an active noise cancelling functionality of the headphone device. For example, such a state or property related to an active noise cancelling functionality may be an activated or deactivated state of the active noise cancelling functionality. As another example, such a state or property related to an active noise cancelling functionality may be a noise reduction level of the active noise cancelling functionality, expressed for example in units of dB or dB(A). According to the principle of active noise cancelling, the at least one loudspeaker driver of the headphone device may generate “anti-noise”, i.e. sound waves which are 180 degrees out of phase compared to a background noise, and since this anti-noise at least partially cancels out the actual background noise, the latter is suppressed or reduced. Thus, the state or property related to an active noise cancelling functionality is in general also related to the sound or sound waves generated by the at least one loudspeaker driver of the headphone device.

As used herein, adjusting at least one sound characteristic of the headphone device based on the at least one construction characteristic determined may be understood such that the at least one construction characteristic determined at least partially influences the adjustment of the at least one sound characteristic. For example, adjusting the at least one sound characteristic may depend on the at least one construction characteristic determined. As another example the result of the adjustment of the at least one sound characteristic may be a function of the at least one construction characteristic determined.

By the method according to the first aspect, an automatic configuration of the headphone device may be achieved without requiring that a user specifies an ear adaption type and/or sound isolation type. More specifically, the method is performed by the headphone device, i.e. it is the headphone device which automatically determines the at least one construction characteristic and adjusts the at least one sound characteristic accordingly. Thus, a respective user action is not necessary.

In an example, determining at least one construction characteristic of the headphone device may comprise:
evaluating a signal measured by a microphone of the headphone device.

In this context, evaluating a signal measured by a microphone of the headphone device may comprise evaluating a volume of the measured signal, i.e. the absolute volume of the signal, expressed for example in units of dB or dB(A). Additionally or alternatively, evaluating a signal measured by a microphone of the headphone device may comprise evaluating a frequency characteristic of the measured signal, i.e. the relative volume of different frequencies of the signal. Additionally or alternatively, evaluating a signal measured by a microphone of the headphone device may comprise comparing the signal measured by the microphone with at least one reference signal. For example, the at least one reference signal may be a current playback signal which is to be converted to sound waves by the at least one loudspeaker driver of the headphone device. As another example, the at least one reference signal may be a stored reference signal which is stored in a memory of the headphone device. As another example, the at least one reference signal may be a signal measured by an additional microphone of the headphone device. Additionally or alternatively, evaluating a signal measured by a microphone of the headphone device may comprise modifying the signal. For example, modifying the signal may comprise extracting a component of the signal. In this context, evaluating a signal measured by a microphone of the headphone device may also comprise evaluating a volume of the modified signal, evaluating a frequency characteristic of the modified signal, and/or comparing the modified signal with at least one reference signal.

By evaluating a signal measured by a microphone of the headphone device, it may be achieved that at least one construction characteristic of the headphone device is determined in a particularly user-convenient way. For example, in a case where the microphone is located on an earcup of an over-ear headphone device such that the microphone is on the side closer to the ear when the over-ear headphone device is worn by a user, it may be possible to infer whether the over-ear headphone device is a closed, open or semi-open headphone device from evaluating a volume of a signal measured by the microphone, evaluating a frequency characteristic of the measured signal, comparing the measured signal with at least one reference signal, modifying the signal, or a combination two or more of these actions. For example, a lower volume of the measured signal and/or a frequency characteristic of the measured signal which predominantly comprises low frequencies may indicate a closed ear adaption type. Conversely, a higher volume of the measured signal and/or a frequency characteristic of the measured signal which comprises essentially a balance between high and low frequencies may indicate an open ear adaption type. As another example, a lower volume of a noise component of the measured signal and/or a frequency characteristic of a noise component which predominantly comprises low frequencies may indicate a closed ear adaption type. Conversely, a higher volume of a noise component and/or a frequency characteristic of a noise component which comprises essentially a balance between high and low frequencies may indicate an open ear adaption type. In this context, a noise component of the measured signal may be determined, as one possible option, by comparing the measured signal with a reference signal such as a current playback signal as defined above, since the measured signal is generally composed of both the current playback signal, generated by the at least one loudspeaker driver and then recorded by the microphone, and background noise reaching the microphone.

In a similar way as described above, it may also be possible to infer whether a headphone device is an over-ear, on-ear, ear-fitting or in-ear headphone device. Furthermore, it may also be possible in a similar way to infer whether an on-ear, ear-fitting or in-ear headphone device is a closed, open or semi-open headphone device. Moreover, the at least one construction characteristic of the headphone device may also be determined in a case where the microphone is located on the headphone device such that the microphone is on the side facing the environment when the over-ear headphone device is worn by a user. In this case, it is conceivable, as one possible option, to compare a frequency characteristic of the current playback signal with a frequency characteristic of the signal measured by the microphone to infer whether the headphone device is a closed, open or semi-open headphone device. For example, a frequency characteristic of the measured signal which comprises a larger amount of low frequencies, compared to the current playback signal, may indicate a closed ear adaption type. Conversely, a frequency characteristic of the measured signal which comprises essentially the same amount of low frequencies, compared to the current playback signal, may indicate an open ear adaption type.

In an example, the microphone may be a microphone used for an active noise cancelling functionality of the headphone device. In other words, the microphone measuring the signal to be evaluated for determining at least one construction characteristic of the headphone device may be a microphone used for an active noise cancelling functionality of the headphone device. Thereby, it may be achieved that the at least one construction characteristic can be determined in a particularly easy way without additional costs for further components. More specifically, active noise cancelling functionalities require the presence of a microphone anyway, and thus, this microphone can be used for determining at least one construction characteristic of the headphone device without requiring an additional microphone. For example, the microphone may be a feedback microphone of an active noise cancelling functionality. For example, the feedback microphone may be arranged on an inner side of the headphone device, i.e. on a side close to the ear when the headphone device is worn by a user. As another example, the microphone may be a feedforward microphone of an active noise cancelling functionality. For example, the feedforward microphone may be arranged on an outer side of the headphone device, i.e. on a side facing the environment when the headphone device is worn by a user.

In an example, determining at least one construction characteristic of the headphone device may comprise:
determining a property or a state of an electronic component integrated into a circuit board of the headphone device.

For example, the electronic component may be an internal resistor of the circuit board and determining a property or a state of the internal resistor may comprise determining the electric resistance of the internal resistor. As another example, the electronic component may be a DIP switch of the circuit board and determining a property or a state of the DIP switch may comprise determining the switching state of the DIP switch. As another example, the electronic component may be a pair of jumper pins of the circuit board and determining a property or a state of the pair of jumper pins may comprise determining whether the jumper pins are connected by a jumper or not. For example, the electronic component may be integrated into a circuit board of the headphone device and configured by a manufacturer during a production process or assembly process of the headphone device according to at least one construction characteristic of the headphone device. For example, in a case where the electronic component is an internal resistor, different electric resistances of the internal resistor may indicate different construction characteristics. For example, in a case where the electronic component is a DIP switch, different switching states of the DIP switch may indicate different construction characteristics. For example, in a case where the electronic component is a pair of jumper pins, the presence or absence of a jumper may indicate different construction characteristics. By determining a property or a state of an electronic component integrated into a circuit board of the headphone device, it may be achieved that at least one construction characteristic of the headphone device is determined in a particularly reliable way.

In an example, determining at least one construction characteristic of the headphone device may comprise:
determining a value of a parameter of a computer program executed by the headphone device.

For example, the value may be set by a manufacturer during a production process of the headphone device according to at least one construction characteristic of the headphone device. For example, different values of the parameter may indicate different construction characteristics. For example, the value of the parameter may be stored in a memory of the headphone device. By determining a value of a parameter of a computer program executed by the headphone device, it may be achieved that at least one construction characteristic of the headphone device is determined in a particularly reliable way.

In an example, the at least one construction characteristic may be an ear adaption type and/or a sound isolation type. Thereby, it may be achieved that an ear adaption type, a sound isolation type, or both, can be determined as the at least one construction characteristic.

In an example, determining at least one construction characteristic of the headphone device may comprise two or more, in particular all, of the following:
evaluating a signal measured by a microphone of the headphone device;
determining a property or a state of an electronic component integrated into a circuit board of the headphone device;
determining a value of a parameter of a computer program executed by the headphone device.

Thereby, the different advantages of the respective actions explained above may be achieved simultaneously. For example, an ear adaption type of the headphone device may be determined by determining a property or a state of an electronic component integrated into a circuit board of the headphone device or by determining a value of a parameter of a computer program executed by the headphone device, and a sound isolation type of the headphone device may be determined by evaluating a signal measured by a microphone of the headphone device.

In an example, adjusting at least one sound characteristic of the headphone device may comprise:
adjusting an equalizer of the headphone device.

Thereby, an undesired frequency response of the headphone device, which is caused by the at least one construction characteristic, e.g. the headphone device having a specific ear adaption type or a specific sound isolation type, may be compensated and thus, a more enjoyable hearing experience for the user may be generated.

In an example, adjusting at least one sound characteristic of the headphone device may comprise:
adjusting an active noise cancelling functionality of the headphone device.

For example, the active noise cancelling functionality of the headphone device may be adjusted in that the active noise cancelling functionality is activated or deactivated. As another example, the active noise cancelling functionality of the headphone device may be adjusted in that be a noise reduction level of the active noise cancelling functionality, expressed for example in units of dB or dB(A), is adjusted. By adjusting an active noise cancelling functionality of the headphone device, it can be achieved that the active noise cancelling functionality is adapted to the at least one construction characteristic, e.g. the headphone device having a specific ear adaption type or a specific sound isolation type, and thus, a more enjoyable hearing experience for the user may be generated.

According to a second aspect, a headphone device is disclosed. The headphone device may comprise:
means for determining at least one construction characteristic of the headphone device; and
means for adjusting at least one sound characteristic of the headphone device based on the at least one construction characteristic determined.

For example, the means for determining at least one construction characteristic of the headphone device may comprise a microphone. For example, the means for determining at least one construction characteristic of the headphone device and/or the means for adjusting at least one sound characteristic of the headphone device based on the at least one construction characteristic determined may comprise a processor and a memory, the memory storing program instructions which, when the program is executed by the processor, cause the headphone device to perform a method according to the first aspect.

The disclosure of any method action in the context of the first aspect, including any specific information regarding the respective method action, is to be considered also as a disclosure of means for performing the respective method action in the context of the second aspect, including the specific information regarding the respective method action.

The means or functionality of the system according to the second aspect may be implemented in hardware and/or software. They may comprise one or multiple modules or units providing the respective functionality. They may for instance comprise at least one processor for executing computer program code for performing the required functions, at least one memory storing the program code, or both.

According to a third aspect, a computer-readable medium is disclosed. The computer-readable medium may be non-transitory. The computer-readable medium according to the third aspect may comprise program instructions which, when the program is executed by a headphone device according to the second aspect, cause the headphone device to perform a method according to the first aspect.

The computer-readable medium may for example be a disk or a memory or the like. The program instructions may be stored in the computer-readable medium in the form of instructions encoding the computer-readable medium. The computer-readable medium may be intended for taking part in the operation of an apparatus, like an internal or external memory, for instance a Read-Only Memory (ROM) or hard disk of a headphone device, or be intended for distribution of the program, like an optical disc.

According to a fourth aspect, a computer program is disclosed. The computer program according to the fourth aspect may comprise instructions which, when the program is executed by a headphone device according to the second aspect, cause the headphone device to perform a method according to the first aspect.

The computer program may be stored on a computer-readable storage medium, in particular a tangible and/or non-transitory computer-readable storage medium. In particular, the computer program according to the fourth aspect may be stored on a non-transitory computer-readable medium according to the third aspect.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows, in a flow chart, an exemplary embodiment of a method according to the first aspect; and

FIG. 2 schematically shows an exemplary embodiment of a headphone device according to the second aspect.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

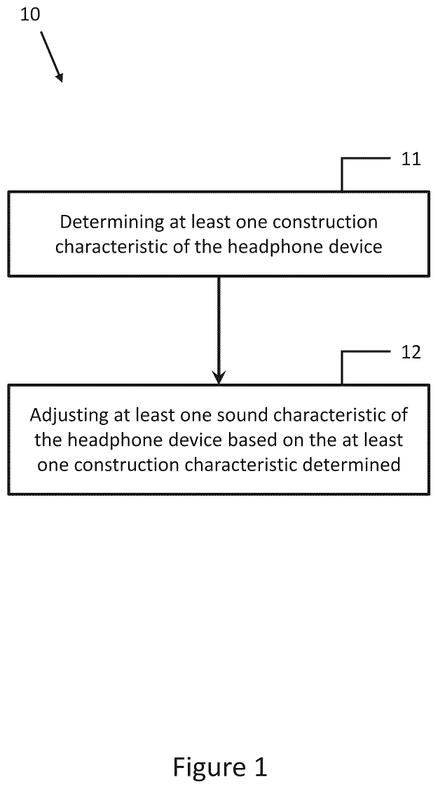

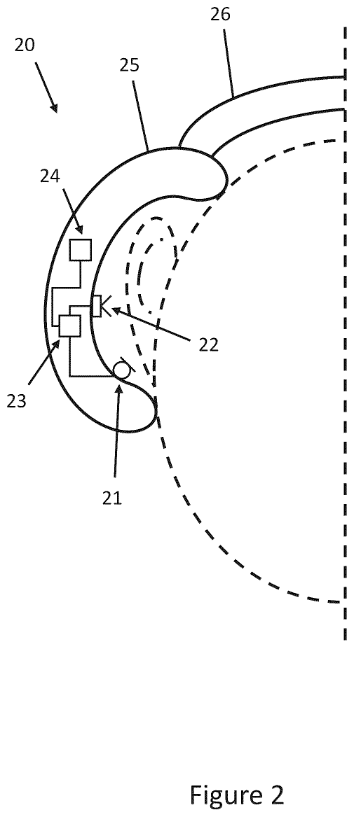

In the following and with reference the FIG. 1, an exemplary embodiment of a method 10 according to the first aspect is described. The method is performed by a headphone device, such as the headphone device 20 described below in the connection with FIG. 2.

Within action 11, at least one construction characteristic of the headphone device is determined. In an embodiment, the at least one construction characteristic is an ear adaption type and/or a sound isolation type.

Within action 12, at least one sound characteristic of the headphone device is adjusted based on the at least one construction characteristic determined. In an embodiment, an equalizer of the headphone device and/or an active noise cancelling functionality of the headphone device is adjusted.

As a result, an automatic configuration of the headphone device may be achieved without requiring that a user specifies an ear adaption type and/or sound isolation type.

FIG. 2 schematically illustrates an exemplary embodiment of a headphone device 20 according to the second aspect.

The headphone device 20 comprises a microphone 21, a loudspeaker 22, a processor 23 and a memory 24. In this specific example, the headphone device 20 is an over-ear headphone device with an earcup 25 and a bracket 26. A head and an ear of a user wearing the headphone device 20 are schematically indicated by the dashed curves. Furthermore, only a left half of the setup is shown for reasons of simplicity. In embodiments, the right half of the headphone device 20, which is not shown, may be identical to the left half shown in FIG. 2. In other embodiments, the right half of the headphone device 20 may be identical only with respect to its outer structure and appearance, but may not comprise some or all of the components shown in FIG. 2 for the left half. In particular, the right half may comprise an additional microphone and an additional loudspeaker, but may not comprise an additional processor and an additional memory.

Furthermore, the headphone device 20 of FIG. 2 comprises:
means for determining at least one construction characteristic of the headphone device; and
means for adjusting at least one sound characteristic of the headphone device based on the at least one construction characteristic determined.

In this regard, reference is also made to the embodiment of the method according to the first aspect explained above in connection with FIG. 1. More specifically, the means for determining at least one construction characteristic of the headphone device comprise the microphone 21, the processor 23 and the memory 24. With respect to this, the memory 24 stores program instructions which, when the program is executed by the processor 23, cause the headphone device 20 to determine at least one construction characteristic of the headphone device. The means for adjusting at least one sound characteristic of the headphone device based on the at least one construction characteristic determined comprise the processor 23 and the memory 24. With respect to this, the memory 24 stores program instructions which, when the program is executed by the processor 23, cause the headphone device 20 to adjust at least one sound characteristic of the headphone device based on the at least one construction characteristic determined. If a sound is generated by the loudspeaker 22 by converting a respective electrical audio signal to sound waves, the sound is then generated with the adjusted at least one sound characteristic.

In embodiments of the headphone device 20, the microphone 21 is an ANC microphone 21, i.e. the microphone 21 is used for an active noise cancelling (ANC) functionality of the headphone device 20. More specifically, the ANC microphone 21 may be a feedback microphone 21. Since the ANC functionality requires the presence of the ANC microphone 21 anyway, this ANC microphone 21 can also be used for determining at least one construction characteristic of the headphone device 20 without requiring an additional microphone, thus saving costs.

In embodiments, the headphone device 20 proceeds as follows when performing a method according to the first aspect: First, the headphone device 20 measures a signal recorded by the microphone 21 at a point of time when no sound waves are generated by the loudspeaker 22. In this case, it can be assumed that the recorded signal is essentially only composed of background noise. Then, the headphone device 20 analyses a frequency characteristic of the recorded signal and determines a sound isolation type and/or an ear adaption type of the headphone device 20. For example, if the recorded signal has a dampened treble, this may indicate a closed sound isolation type and/or an over-ear ear adaption type. After detecting a closed over-ear headphone device, the headphone device 20 accordingly adjusts an equalizer for sound waves generated by the loudspeaker 22. As a non-limiting example, the headphone device 20 may adjust the equalizer such that treble is reduced. Furthermore, after detecting a closed over-ear headphone device, the headphone device 20 accordingly adjusts a noise cancelling functionality. As a non-limiting example, the headphone device 20 may activate the noise cancelling functionality and may increase the noise reduction level for low frequencies.

In embodiments, the headphone device 20 may also measure a signal recorded by the microphone 21 at a point of time when sound waves are generated by the loudspeaker 22. In this case, it can be assumed that the recorded signal is composed of an output signal of the loudspeaker 22 and background noise. The headphone device may then eliminate the output signal of the loudspeaker 22 from the recorded signal, e.g. by subtracting a signal proportional to the electrical audio signal corresponding to the output signal of the loudspeaker 22 from the recorded signal. Using this modified recorded signal, the headphone device may then proceed as described above, i.e. analyse a frequency characteristic of the modified recorded signal and determine a sound isolation type and/or an ear adaption type of the headphone device 20.

In embodiments where the microphone 21 is a feedback microphone 21 of an ANC functionality, the headphone device 20 may comprise an additional feedforward microphone (not shown) of the ANC functionality located on the outer side of the headphone device, i.e. on a side facing the environment when the headphone device is worn by a user. In these cases, the headphone device 20 may proceed as follows when performing a method according to the first aspect: First, the headphone device 20 may measure a first signal recorded by the feedback microphone 21 and a second signal recorded by the feedforward microphone at a point of time when no sound waves are generated by the loudspeaker 22. Then, the headphone device 20 may subtract the first signal from the second signal to obtain a modified recorded signal. Furthermore, the headphone device 20 may analyse a frequency characteristic of the modified recorded signal and determine a sound isolation type and/or an ear adaption type of the headphone device 20. For example, if the modified recorded signal has essentially only treble components, this may indicate a closed sound isolation type and/or an over-ear ear adaption type. After detecting a closed over-ear headphone device, the headphone device 20 may proceed analogously as above, i.e. accordingly adjust an equalizer and accordingly adjust the ANC functionality.

In embodiments, the headphone device 20 uses the microphone 21 only for determining a sound isolation type of the headphone device 20. In these cases, an ear adaption type of the headphone device 20 may not be determined at all. Alternatively, an ear adaption type of the headphone device 20 may be determined by determining a property or a state of an electronic component (not shown) integrated into a circuit board (not shown) of the headphone device 20. As non-limiting examples, the headphone device 20 may determine the electric resistance of an internal resistor on the circuit board, determine the switching state of a DIP switch on the circuit board, or determine whether jumper pins on the circuit board are connected by a jumper or not. The internal resistor, DIP switch or jumper pins may be configured by a manufacturer during a production process or assembly process of the headphone device 20 according to an ear adaption type of the headphone device 20. For example, a first switching state of a DIP switch may indicate an over-ear headphone device and a second switching state if a DIP switch may indicate an on-ear headphone device. As another example, a first electric resistance value of an internal resistor may indicate an over-ear headphone device and a second electric resistance value of an internal resistor may indicate an on-ear headphone device. Additionally or alternatively, an ear adaption type of the headphone device 20 may be determined by determining a value of a parameter of a computer program executed by the headphone device 20. The value may be set by a manufacturer during a production process of the headphone device 20 according to an ear adaption type of the headphone device 20. For example, a first value of the parameter may indicate an over-ear headphone device and a second value of the parameter may indicate an on-ear headphone device. For example, the value of the parameter may be stored in the memory 23.

In embodiments not shown in FIG. 2, the headphone device may be an in-ear hearable with ANC functionality and exchangeable ear tips. The ear tips selected by a user determine whether the sound isolation type of the hearable is open or closed. The hearable detects the sound isolation type using an ANC microphone and compensates the EQ and ANC functionality accordingly.

### A Computer Program:

A computer program (product) comprising instructions which, when the program is executed by a computer, cause the computer to carry out (steps of) the method described above, in the ‘detailed description of embodiments’ and in the claims is furthermore provided by the present application. One or more (e.g. all) parts of the method may be implemented in software.

### A Computer Readable Medium:

In an aspect, the functions may be stored on or encoded as one or more instructions or code on a tangible computer-readable medium. The computer readable medium includes computer storage media adapted to store a computer program comprising program codes, which when run on a processing system causes the data processing system to perform at least some (such as a majority or all) of the steps of the method described above, in the and in the claims.

By way of example, and not limitation, such computer-readable media may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. In addition to being stored on a tangible medium, the computer program may also be transmitted via a transmission medium such as a wired or wireless link or a network, e.g. the Internet, and loaded into a data processing system for being executed at a location different from that of the tangible medium. One or more (e.g. all) parts of the method may be implemented in software.

### A Data Processing System:

In an aspect, a data processing system may comprise a processor adapted to execute the computer program for causing the processor to perform at least some (such as a majority or all) of the steps of the method described above and in the claims. One or more (e.g. all) parts of the method may be implemented in software.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more.

Accordingly, the scope should be judged in terms of the claims that follow.

1. A method performed by a headphone device, the method comprising:
determining at least one construction characteristic of the headphone device; and
adjusting at least one sound characteristic of the headphone device based on the at least one construction characteristic determined.

2. The method according to claim 1, wherein determining at least one construction characteristic of the headphone device comprises:
evaluating a signal measured by a microphone of the headphone device.

3. The method according to claim 2, wherein the microphone is a microphone configured for an active noise cancelling functionality of the headphone device.

4. The method according to claim 1, wherein determining at least one construction characteristic of the headphone device comprises:
determining a property or a state of an electronic component integrated into a circuit board of the headphone device.

5. The method according to claim 1, wherein determining at least one construction characteristic of the headphone device comprises:
determining a value of a parameter of a computer program executed by the headphone device.

6. The method according to claim 1, wherein the at least one construction characteristic is an ear adaption type and/or a sound isolation type.

7. The method according to claim 1, wherein adjusting at least one sound characteristic of the headphone device comprises:
adjusting an equalizer of the headphone device.

8. The method according to claim 1, wherein adjusting at least one sound characteristic of the headphone device comprises:
adjusting an active noise cancelling functionality of the headphone device.

9. A headphone device configured to:
determine at least one construction characteristic of the headphone device; and
adjust at least one sound characteristic of the headphone device based on the at least one construction characteristic determined.

10. The headphone device according to claim 9, further comprising a processor carrying out the adjustment of the at least one sound characteristic.

11. The headphone device according to claim 9, further comprising a processor carrying out the determination of the at least one construction characteristic.

12. A computer program comprising instructions which, when the program is executed by
the headphone device of claim 9, cause the headphone device to perform a method comprising:
determining the at least one construction characteristic of the headphone device; and
adjusting the at least one sound characteristic of the headphone device based on the at least one construction characteristic determined.
